(19) United States
(12) Patent Application Publication
(10) Pub. No.: US 2022/0280392 A1
(43) Pub. Date: Sep. 8, 2022

(54) TEMPERATURE INDICATOR CONTAINER

(71) Applicant: SCARLO PTY LTD, Geelong West (AU)

(72) Inventor: Melinda BAXTER, Geelong West (AU)

(21) Appl. No.: 17/639,580

(22) PCT Filed: Sep. 1, 2020
(86) PCT No.: PCT/AU2020/000097

§ 371 Date: Mar. 1, 2022

(30) Foreign Application Priority Data
Sep. 3, 2019 (AU) 2019903241

(51) Int. Cl. A61J 9/02; A61J 9/08; A61J 9/00; B65D 51/24; A47J 41/02; A47J 41/00

(52) U.S. Cl. CPC A61J 9/02; A61J 9/085; A61J 9/001; B65D 51/248; A47J 41/028; A47J 41/0094; A61J 2205/20; A61J 2200/50; A61J 2200/72; A47J 2202/00

(57) ABSTRACT

A container that provides temperature range indication to a user, the container including a chamber for holding heated liquid and a cap having a visual indicator and a temperature sensor, wherein in use the visual indicator illuminates a plurality of visual colours representing to the user the discrete temperature range of the heated liquid. The container is suitable for infant formula preparation and feeding.

### FIELD OF THE INVENTION

The present invention relates to a temperature indicator container and more particularly temperature indicator container used to retain heated liquids for infant formula preparation.

### BACKGROUND OF THE INVENTION

Conventionally, it has been recognized that milk/formula given to unweaned babies or infants should be at the correct temperature. If the milk/formula liquid is too hot, the infant or baby's lips and mouth may be burned. If the milk/formula liquid is too cold, it may bring a case of indigestion or constipation.

There is always a need for careers or parents to serve a fresh bottle of baby or infant formula promptly at the correct temperature, to avoid any delays caused by heating or cooling of the infant formula.

Conventionally in the past, the most common method for determining the temperature of the liquid for infant feeding was simply by the use of the tactile feeling of the fingertip, hand palm or elbow of the person having access to the feeding bottle. This determination was therefore often unreliable, as it simply depended upon the thermal feeling and guess work of that person having access to the feeding bottle and furthermore, was not free from the influences of atmospheric or room temperature.

Other temperature indicator means used in baby bottles included the use of liquid bulb-type thermometers attached, by various methods, to the feeding bottle. With respect to using liquid bulb-type thermometers there is the obvious breakage risk, resulting from the fact that the bottle is being used by an infant and thus might be dropped or the bottle misused by the infant, thus possibly leading to cuts or poisoning.

There is a now a need for a temperature indicator container that attempts to ameliorate any one or more of the above problems.

### SUMMARY OF INVENTION

Accordingly, the present invention provides a container that provides temperature range indication to a user, the container including:

a chamber for holding heated liquid;

an outlet for dispensing the heated liquid from the chamber;

a cap sealably connected to the outlet;

the cap including:
(a) a visual indicator adapted to selectively illuminate a plurality of visual colours, wherein each one of the visual colours represents a pre-determined discrete temperature range;
(b) a temperature sensor, extending inside the chamber that measures the temperature of the heated liquid;
(c) a power supply adapted to power the temperature sensor and visual indicator; and
(d) a switch operable by the user to engage the power supply;
(e) a processor that correlates the measured temperature of the heated liquid from the temperature sensor with the visual indicator,

wherein in use, illumination of each one of the visual colours represents to the user the discrete temperature range of the heated liquid.

It is preferred that the chamber is manoeuvrable so that the heated liquid contacts the temperature sensor.

It is preferred that the processor includes a printed circuit board having an integrated circuit programmed to process an input signal to an output signal.

It is preferred that the input signal originates from the temperature sensor and the output signal is directed to the visual indicator.

It is preferred that the visual indicator includes a red, green, blue light colour emitting diode.

One advantage of the container that provides temperature range indication to a user, is that the visual indicator illustrates to the user that the heated liquid is safe to use for baby infant formula preparation.

Another advantage of the container that provides temperature range indication to a user, is that there is no liquid bulb-type thermometer making it safer to use for infants and babies.

It will be convenient to hereinafter to describe the invention with reference to the following drawings which shows thirteen (13) preferred embodiments of the container that provides temperature range indication to a user and the particularity of the attached drawings and following description should not supersede or limit the preceding broad definition of the invention.

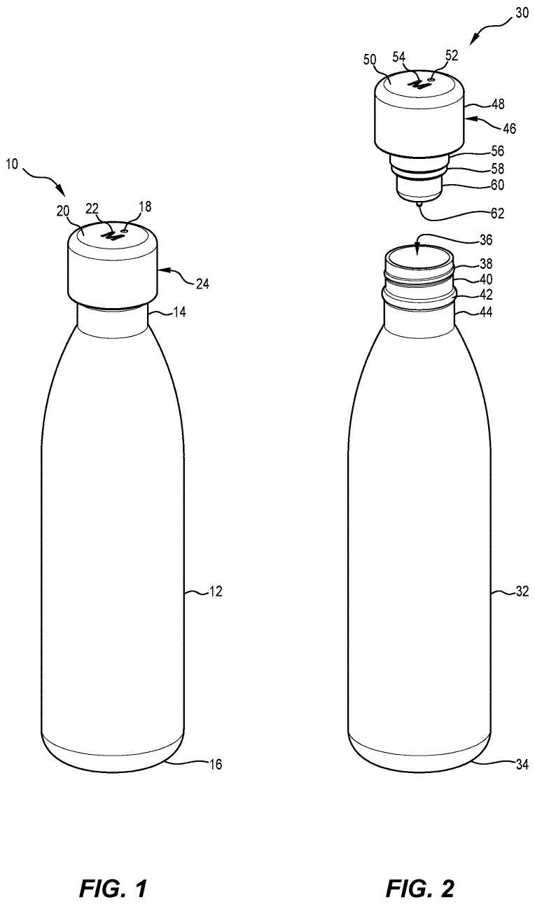

FIG. 1, is a front perspective view from above of the container that provides temperature range indication to a user, illustrating a connected cap, according to a first preferred embodiment of the invention;

FIG. 2 is a front perspective view from above of the container that provides temperature range indication to a user of FIG. 1, illustrating a disconnected cap, according to a second preferred embodiment of the invention;

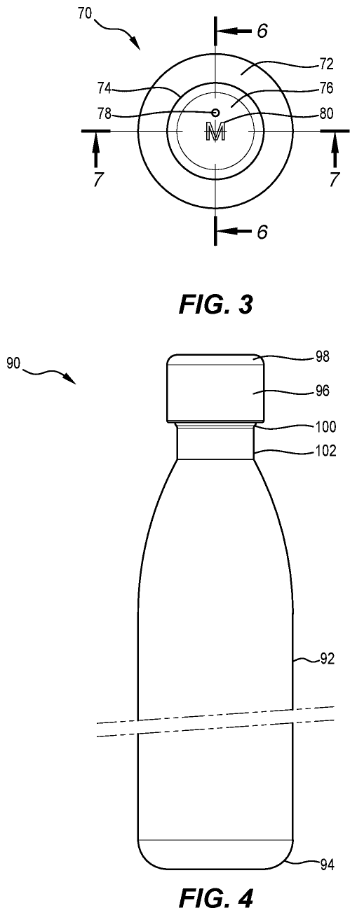

FIG. 3 is a top view of the container that provides temperature range indication to a user of FIG. 1, according to a third preferred embodiment of the invention;

FIG. 4 is a side perspective view of the container that provides temperature range indication to a user of FIG. 1 according to a fourth preferred embodiment of the invention;

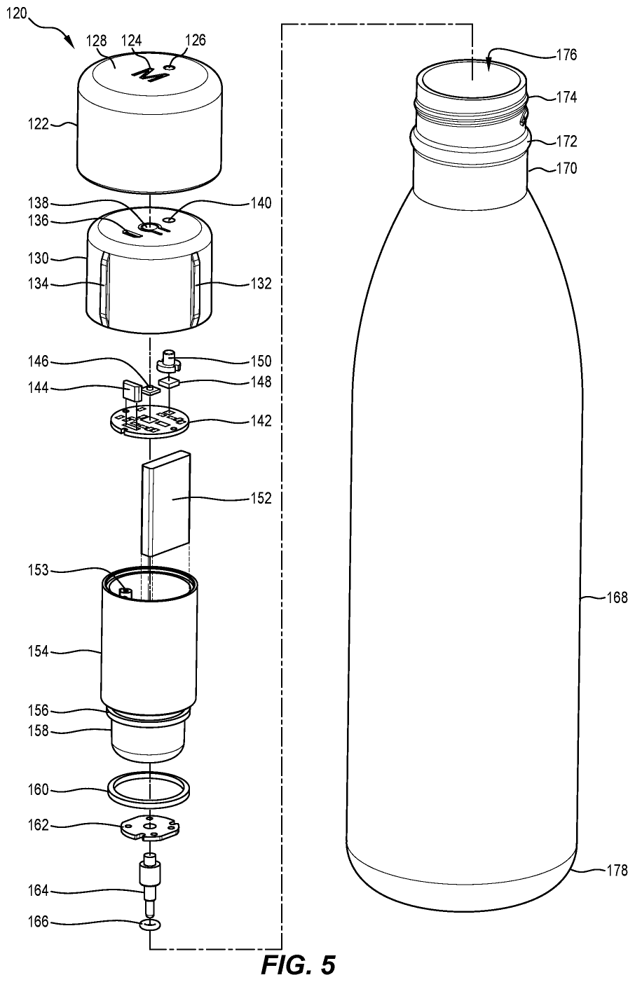

FIG. 5 is an exploded view of the container that provides temperature range indication to a user of FIG. 1 according to a fifth preferred embodiment of the invention;

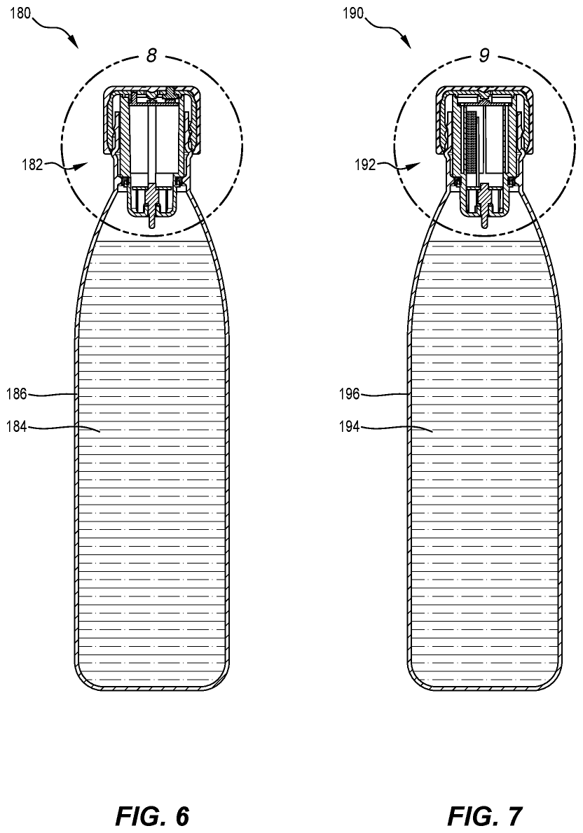

FIG. 6 is a cross sectional view of the container that provides temperature range indication to a user of FIG. 4, taken through section “6-6” of FIG. 3, according to a sixth preferred embodiment of the invention;

FIG. 7 is a cross sectional view of the container that provides temperature range indication to a user of FIG. 4, taken through section “7-7” of FIG. 3, according to a seventh preferred embodiment of the invention;

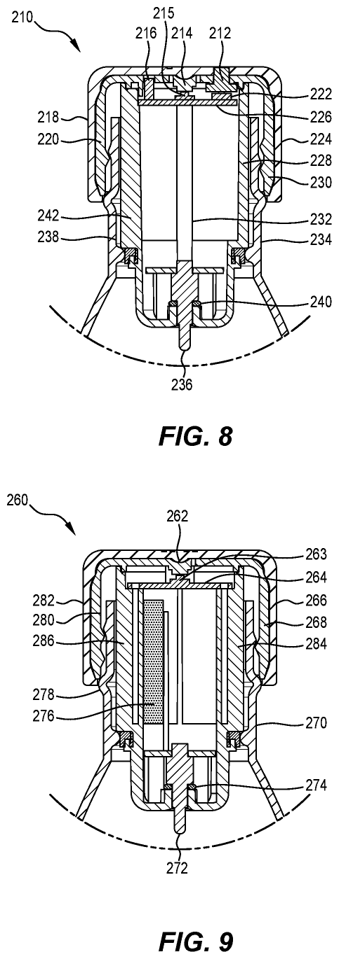

FIG. 8 is an enlarged view of the container that provides temperature range indication to a user, taken through circle section 8 of FIG. 6, according to an eighth preferred embodiment of the invention;

FIG. 9 is an enlarged view of the container that provides temperature range indication to a user, taken through circle section 9 of FIG. 7, according to a ninth preferred embodiment of the invention;

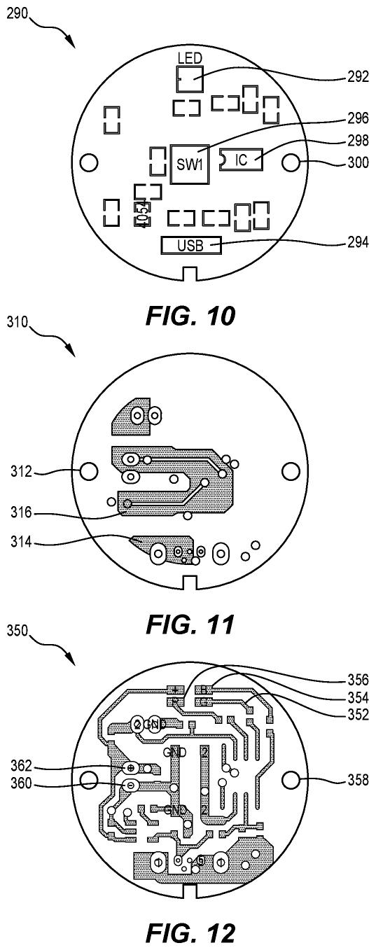

FIG. 10 is a top view of an upper silkscreen layer of the printed circuit board within the container that provides temperature range indication to a user of FIG. 5, according to a tenth preferred embodiment of the invention;

FIG. 11 is a top view of a middle solder-mask layer relative to the upper silkscreen layer of FIG. 10, according to an eleventh preferred embodiment of the invention;

FIG. 12 is a top view of a lower solder-mask layer relative to the upper silkscreen layer of FIG. 10, according to a twelfth preferred embodiment of the invention; and

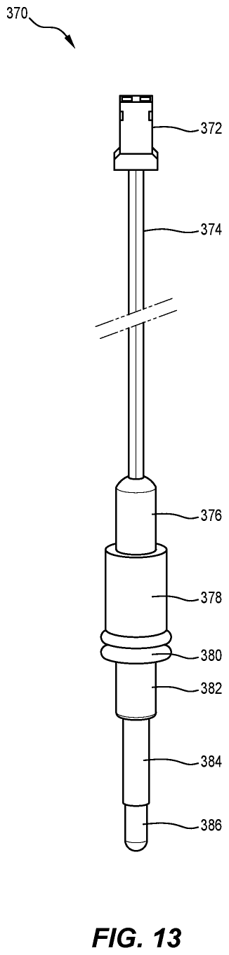

FIG. 13 is a front perspective view of the temperature sensor within the container that provides temperature range indication to a user of FIG. 5, according to a thirteenth preferred embodiment of the invention.

### DETAILED DESCRIPTION OF THE INVENTION

In this specification including the claims and drawings the phrase “heated liquid” means: heated sterile water suitable for baby or infant formula; and heated water suitable for coffee and tea.

Now referring to FIG. 1, is a front perspective view from above of the container that provides temperature range indication to a user, illustrating a connected cap 10, having a chamber 12, which holds the heated liquid. The chamber 12 is supported by a base 16. The chamber 12 is a bottle shape constructed from two (2) ply aluminium material. The chamber 12 has an additional outer wall and an inner wall, both not illustrated in FIG. 1. Positioned between the outer wall and inner wall there is an insulation layer comprising a vacuum space (not illustrated in FIG. 1). The inner wall is externally coated in the exposed position relative to the vacuum space with copper coating finish to provide greater heat insulation capability to maintain the temperature of the heated liquid inside the chamber 12. The vacuum space (not illustrated) functions to provide further heat insulation capacity for the chamber 12. The chamber 12 can be of any suitable volume, but it is preferred to be of in the order of 750 ml. The materials used for the outer wall and inner wall of the chamber 12 is that it is constructed from 304 grade stainless steel. The outer wall of the chamber 12 is finished with coated paint to make the container that provides temperature range indication to a user illustrating a connected cap 10 aesthetically pleasing.

Advantageously, given the structure of the chamber 12 described above, the chamber 12 can maintain the heated liquid for up to twelve (12) hours which allows users to obtain to multiple feeds for baby formulations at a safe temperature out of the container that provides temperature range indication to a user 10.

The chamber 12 extends to a neck 14 made from the same 304 grade stainless steel material as the inner wall and outer wall of the chamber 12. The cap 24 in FIG. 1 illustrates being connected to the chamber 12, with the visual indictor 18 being positioned at the top of the cap 24. The cap 24 will be fully described further below, but which in FIG. 1 has a removable cover 20 which is constructed from flexible silicone material that can be fully removed and flexibly fitted on the remaining aspects of the cap 24 which will be fully described further below. The removable cover 20 accommodates flexibility so that the flexible button 22 can be operated by manipulation of the user's fingers to press the flexible button 22 in order to operate the switch (not illustrated in in FIG. 1). The letter “M” is merely ornamental having no technical purpose and any other symbol or letter can be used.

Now FIG. 2 is a front perspective view from above of the container that provides temperature range indication to a user of FIG. 1 illustrating a disconnected cap 30, which provides the chamber 32 having the base 34, which in turn provides the necessary support, such that the chamber 32 can stand in an upright position. The chamber 32 upwardly extends to the neck 44 and further to the neck 40 which has a thread 38 which is a broad, circular and discontinuous thread around the neck 44 and neck 40. In this embodiment, the thread 38 is broad, circular and discontinuous around the neck 44 and neck 40 including additional finer threads protruding thereon. That is, the thread 38 is clever having a unique finer thread overlaying a novel, broad, circular and discontinuous thread. That is, a discontinuous broad thread and another thread having raised channels disposed on the broad thread. The thread 38 provides the required engagement structure with the cap 46, such that the cap 46 can be securely pressed down and then screwed around the neck 40 and neck 44 by the user's hand. In the alternative embodiment, the thread 38 is running continuously and circumferentially around the neck 44 and neck 40. On the neck 44 is a rim 42 that also provides a closing and sealing function. The cap 46 can then connect with the outlet 36 by sealed engagement and/or inter-engagement. At the top of the neck 40 is an outlet 36 that functions to dispense the heated liquid from inside of the chamber 32. The outlet 36 is quite unique relative to the chamber 32 in that the upward extension from the neck 44 and further to the neck 40 provides a uniquely dimensioned outlet 36 which is unusually narrow to that known in the art, that provides easier and safer pouring of the heated liquid from the chamber 32, thereby reducing spillage. The unique and clever narrower neck 44 and neck 40 relative to the chamber 32 also prevents heat escape of the heated liquid from within the chamber 32.

The cap 46 has a removable cover 48 on the side of the cap 46 and removable cover 50 extending on the top all of which is constructed from flexible silicone material that allows the user to fully remove and flexibly fit back on. The visual indicator 52 at the top of the cap 46, illuminates a plurality of visual colours namely the colours, red, green and blue to the user, each specific colour of which represents to the user a discrete temperature range of the heated liquid in the chamber 32, which will be described more fully below. The flexible button 54 can be pressed by the user's finger to operate the switch (not illustrated) which will be described more fully below.

The cap 46 further has an upper annulus 56 which assists providing the stopper and sealing function of the cap 46 by sliding engagement with the outlet 36 and internal wall of the neck 40. Immediately extending below the upper annulus 56 is a medial annulus 58 that also provides engagement function by also providing the stopper and sealing function of the cap 46 by insertion through the outlet 36. Extending below the medial annulus 58 is the boss 60 having a temperature sensor 62 extending therethrough below. The temperature sensor 62 functions to measure the temperature of the heated liquid inside the chamber 32. Depending on how high the level of the heated liquid is inside the chamber 32, the temperature sensor either sits above or below the level of the heated liquid inside the chamber 32. When the temperature sensor 62 sits above the level of the heated liquid it will be necessary for the user to manoeuvre the chamber 32, by tilting the chamber 32 such that the heated liquid runs over and contacts with the temperature sensor 32. Similarly, when the temperature sensor 62 sits below the level of the heated liquid it will not be necessary for the user to manoeuvre the chamber 32.

Now turning to FIG. 3 is a top view of the container that provides temperature range indication to a user 70 of FIG. 1 illustrating the chamber 72 and centrally located cap 74 having a removable cover 76 and a visual indicator 78 and adjacent flexible button 80. The letter “M” is merely ornamental having no technical purpose and any other symbol or letter can be used.

Having regard to FIG. 4 is side perspective view of the container that provides temperature range indication to a user 90 of FIG. 1, having a chamber 92 of any variable length having its base 94. Extending upward from the chamber 92 is the neck 102 with the rim 100 exposed on the external side of the neck 102. The rim 100 provides closing and sealing function. Above the rim 100 is the cap 96 with the removable cover 98.

Turning to FIG. 5 is an exploded view of the container that provides temperature range indication to a user 120 of FIG. 1, with the chamber 168 supported by the base 178. Extending above from chamber 168 is the neck 170 extending then to a rim 172. A thread 174 running discontinuously (and in the alternative embodiment continuously), and circumferentially around the neck 170 which provides the required engagement structure with the cap (not illustrated in its assembled form), such that the cap (not illustrated in its assembled form), can be pressed down and securely screwed onto the neck 170 and over the outlet 176 by the user. At the top of the neck 170 is an outlet 176 that functions to dispense the heated liquid from the inside the chamber 168. The cap (not illustrated in its assembled form but exploded form) has a removable cover 122 extending from the side of the cap (not illustrated in its assembled form but exploded form) and continuing over to the removable cover 128 of which is constructed from flexible silicone material that allows the user to fully remove and flexibly fit back on over the internal cap 130 which is constructed from harder resilient polyvinyl chloride (PVC) or injection moulded plastics.

Located on the removable cover 128 is an aperture 126 that provide the opening for the red, green and blue colour light emitting diode 150 to sit under the aperture 126, such that a plurality of visual colours can illustrate visually to the user. A flexible button 124 is positioned on the removable cover 128 which can be pressed by the user's finger to operate the switch 146 which will be described more fully below.

The internal cap 130 provides the necessary stable structure having at its top an opening with a biased leaf 138 which is spring loaded or flexibly biased that can move and depress upon the pressing action by the user's finger on the flexible button 124, which in turn engages the biased leaf 138. In addition, at the top of the internal cap 130 is an aperture 140 which cooperates with the aperture 126 located on the removeable cover 128 such that the light emitting diode 150 can emit light therethrough both the aperture 140 and aperture 126 when assembled. The internal cap 130 at the top also has a charging port 136 for electric charging of a rechargeable battery 152. The power supply can be either a non-chargeable battery or a rechargeable battery 152. The charging port 136 provides the opening to a USB port 144 that allows the user to use a mobile telephone charging cable, for example, to recharge the rechargeable battery 152. The charging port 136 is quite advantageous as the heated liquid (not illustrated) can be maintained heated within the chamber 168 even when the rechargeable battery 152 is being recharged. All what is required is for the user to remove the removable cover 122 and utilize the USB port 144 in the charging port 136. The internal cap 130 also on its side has a projection 132 and projection 134 that each provide the necessary engagement structure for the removable cover 122, to securely fasten by flexible engagement.

Now, inside the internal cap 130 is the necessary electronics including a printed circuit board 142 which has the USB port 144 affixed thereto so that the recharging function using electrical current can pass through to the rechargeable battery 152. The printed circuit board 142 also includes the switch 146 that operates by interconnection resulting from hand pressure from a user's fingers engaging the flexible button 124, which in turn engages the biased leaf 138 to further engage the switch 146 that creates an electrical circuit through which the printed circuit board 142 electrically charges both the integrated circuit 148 which is programmed to operate and power the light emitting diode 150 and the temperature sensor 164. The printed circuit board 142 is physically secured by a boss 153 having an opening to receive screws to fasten to the printed circuit board 142. The boss 153 is internally secured to a cylindrical sleeve 154 which forms the basis of the upper annulus 56 of FIG. 2. There is an additional boss (not illustrated) but internally secured to the cylindrical sleeve 154 that provides additional securement function of the printed circuit board 142. Extending below the cylindrical sleeve 154, presents a narrowed medial annulus 156 having externally exposed threads that receives a bung 160 which functions to close and seal the cap (not illustrated in FIG. 5 in its assembled form but in its exploded form) as a whole from its outside. Extending below the medial annulus 156 is a boss 158. The base plate 162 closes the boss 158, whilst allowing the temperature sensor 164 to protrude through the base plate 162 which is sealed by the O-ring washer 166.

Now turning to FIG. 6 is cross sectional view of the container that provides temperature range indication to a user 180 of FIG. 4, taken through section “6-6” of FIG. 3, which illustrates the chamber 186 holding or retaining the heated liquid 184. The person skilled in the art would appreciate by interpreting FIG. 6, that given the level of the heated liquid 184 inside the chamber 186, the chamber 186 will need to be maneuvered by the user by tilting so that the heated liquid 184 contacts with the temperature sensor (not numbered but illustrated to the person skilled in the art) to correctly measure the temperature of the heated liquid 184 which will be fully described below. Circle section 8 of the cap 182 (not numbered in FIG. 6) is illustrated further in FIG. 8.

Now turning to FIG. 7 is a cross sectional view of the container that provides temperature range indication to a user 190 of FIG. 4, taken through section “7-7” of FIG. 3, which illustrates the chamber 196 holding the heated liquid 194. The person skilled in the art would appreciate by interpreting FIG. 7, that given the level of the heated liquid 194 inside the chamber 196, the chamber 196 will need to be maneuvered by the user by tilting so that the heated liquid 194 contacts with the temperature sensor (not numbered but illustrated to the person skilled in the art) to correctly measure the temperature of the heated liquid 194 which will be fully described below. Circle section 9 of the cap 192 (not numbered in FIG. 7) is illustrated further in FIG. 9.

For the avoidance of doubt, the person skilled in the art will appreciate that both FIG. 6 and FIG. 7 do not illustrate the inner wall and outer wall of the chamber 186 of FIG. 6 and chamber 196 of FIG. 7 in these embodiments. In further embodiments, the chamber 186 of FIG. 6 and chamber 196 of FIG. 7 can have an additional outer wall and an inner wall. Positioned between the outer wall and inner wall where there is an insulation layer comprising a vacuum space (not illustrated in FIG. 6 and FIG. 7). The inner wall is externally coated in the exposed position relative to the vacuum space with copper coating finish to provide greater heat insulation capability to maintain the temperature of the heated liquid 184 inside the chamber 186 of FIG. 6 and heated liquid 194 of chamber 196 of FIG. 7. The vacuum space (not illustrated FIG. 6 and FIG. 7) functions to provide further heat insulation capacity for the chamber 186 of FIG. 6 and chamber 196 of FIG. 7.

Now turning to FIG. 8 is an enlarged view of the container that provides temperature range indication to a user, taken through circle section 8 of FIG. 6, illustrating the cap 210, having the light emitting diode 212, being a tri-colour LED illuminating red colour, blue colour and green colour, which is further described below. The biased leaf 214 is spring loaded or flexibly biased that can move and depress upon the pressing action by the user's finger on the flexible button (not numbered) situated on the removable cover 218 (which extends to the removable cover 224) which in turn engages the switch 215. A USB port 216 is located on the printed circuit board 226 which has an integrated circuit 222 affixed thereto that is operationally connected to the light emitting diode 212. Extending below the cap 210 is the temperature sensor 236 which is a thermistor type sealed from moisture by the O-ring washer 240. The temperature sensor 236 extends through the middle of the cap 210 by way of a tube 232 constructed from poly-vinyl chloride (PVC) having internally, electrically conductive side by side wiring that provides variable electrical resistance to a current dependent on its temperature (which will be described more fully below) that is operationally connected to the printed circuit board 226. The temperature sensor 236 ultimately extends and protrudes through the cap 210 below. Operationally, the cap 210 slide fits over the neck 238 of the container (not illustrated) in the annular space between internal cap 220 and the cylindrical sleeve 242 and the cap 210 also slide fits over the neck 234 of the container (not illustrated) in the annular space between internal cap 230 and the cylindrical sleeve 228 and the user presses the cap 210 down over the outlet (not numbered) and utilises the unique threads (not numbered but described herein) on the neck 234 by twisting around the outlet (not numbered) securely.

Turning to FIG. 9 is an enlarged view of the container that provides temperature range indication to a user, taken through circle section 9 of FIG. 7 illustrating the cap 260 having the biased leaf 262 which is spring loaded or flexibly biased that can move and depress upon the pressing action by the user's finger on the flexible button (not numbered) located on the removeable cover 282 which in turn engages the switch 263. The flexible button (not numbered) situated on the removable cover 282 which in turn extends to removable cover 266 on the other side of the cap 260. Extending below the cap 260 is the temperature sensor 272 which is a thermistor type sealed from moisture by the O-ring washer 274. The temperature sensor 272 extends through the middle of the cap 260 that is operationally connected to the printed circuit board 264 via a tube of which the person skilled in the art would appreciate is partially blocked from view (near the lower end) by the internal moulding structures of the cap 260. The temperature sensor 272 ultimately extends and protrudes through the cap 260 below, which is sealed from moisture by the O-ring washer 274. Operationally, the cap 260 slide fits over the neck 278 of the container (not illustrated) in the annular space between internal cap 280 and the cylindrical sleeve 286 and the cap 260 slide fits over the neck 270 of the container (not illustrated) in the annular space between internal cap 268 and the cylindrical sleeve 284. The slide fit also is securely sealed by the threads (described herein) in the neck 278 and the neck 270 by hand twisting by the user of the cap 260 creating sealed interengagement. The rechargeable battery 276 is located therein to power the container that provides temperature range indication to a user of FIG. 7. The rechargeable battery 276 is of any suitable type in the field such as a polymer lithium battery having 3.7V, 250 mAh° The rechargeable battery charger voltage that users should charge the rechargeable battery 276 is about 5V and 10 using, for example, a mobile iPhone™ charging block.

The person skilled in the art would appreciate that the cap 210 of FIG. 8 and cap 260 of FIG. 9 is constructed from injection moulded plastics, ABS Food grade plastics or poly vinyl chloride (PVC), with internal electrical systems so that the cap 210 of FIG. 8 and cap 260 of FIG. 9 is water resistant to operate when the heated liquid (not illustrated) contacts the relevant temperature sensor 272 of FIG. 9 and temperature sensor 236 of FIG. 8.

FIG. 10 is a top view of an upper silkscreen layer of the printed circuit board within the container that provides temperature range indication to a user of FIG. 5, illustrating the silkscreen layer 290 and the component outlines including the light emitting diode LED region 292 to secure the tri-colour LED illuminating red colour, blue colour and green colour, and the USB Region 294 that receives a Type A male USB type standard mobile telephone charging cable for charging the rechargeable battery (not illustrated) and the switch region 296 and the integrated circuit region 298, which may also include a thermistor type integrated circuit programmed to cooperate with the temperature sensor (not illustrated in FIG. 10). The secure hole 300 is used to secure the various layers of the printed circuit board (when fully assembled) to be secured to a boss (see boss 153 of FIG. 5).

FIG. 11 is a top view of a middle solder-mask layer relative to the upper silkscreen layer of FIG. 10, illustrating the solder mask layer 310 having the secure hole 312 is used to secure the various layers of the printed circuit board (when fully assembled) to be secured to a boss (see boss 153 of FIG. 5). A first solder region 314 having tracking and a second solder region 316 having further tracking.

FIG. 12 is a top view of a lower solder-mask layer relative to the upper silkscreen layer of FIG. 10 illustrating the solder mask layer 350 having a green solder region 352 which is used to provide electronic circuit functionality to activate the green LED light and a blue solder region 354 is used to provide electronic circuit functionality to activate the blue LED light and red solder region 356 is used to provide electronic circuit functionality to activate the red LED light. The secure hole 358 is used to secure the various layers of the printed circuit board (when fully assembled) being FIG. 10, FIG. 11 and FIG. 12 on the relevant substrate known in the art, which is secured to a boss (see boss 153 of FIG. 5). Located opposite to the secure hole 358 is another secure hole (not numbered) adjacent to a negative charge point for the rechargeable battery 360 and positive charge point for the rechargeable battery 362.

FIG. 13 is a front perspective view of the temperature sensor within the container that provides temperature range indication to a user of FIG. 5, the temperature sensor 370, which is a thermistor type having a connector shell 372 which operatively engages the switch (not illustrated) on the printed circuit board (also not illustrated). The connector shell 372 is connected to a side by side wire 374 of variable length and suitable material having an electrical resistance function which is enclosed by a polyvinyl chloride (PVC) tube. A bullet shaped shell 376 extends to a cylindrical shell 378 further below with a covered epoxy resin region 380 for providing impermeably as well as providing secured sealing and electrical resistance to prevent the heated liquid in the container (both not illustrated) from entering inside the cap (not illustrated). The materials used for the temperature sensor 370 include those being metal oxides. An upper electrical resistance region 382 of about 23 mm in length, which protrudes outside the cap (not illustrated) when assembled, extends to the mid electrical resistance region 384 of about 5.5 mm and the end electrical resistance region 386 of about 2 mm the latter of which extends most into the chamber (not illustrated). The mid electrical resistance region 384 has a capacity of 100K (kelvin)±1%. The temperature sensor 370 thermistor functional characteristics which include (i) a zero power resistance: R25=100 KΩ (ii) B Value of B25/50=3950 k±1%; (iii) a thermal time constant: 16 s max (iv) a dissipation constant: 2.0 mW/° C.; (v) power rating: 10 mW and (vi) and an operating temperature range of −30° C. to 108° C. The overall length of the temperature sensor 370 is at least 115 mm±5 mm.

The temperature sensor 370 is an NTC being a negative temperature co-efficient type using the following temperature resistance table below utilizing known metal conductive wiring materials used in the art and having the following characteristics:

TEMPERATURE VS RESISTANCE TABLE
Resistance 100 k Ohms at 25 deg. C.
Resistance Tolerance +/−1%
B Value 3950K at 25/50 deg. C.
B Value Tolerance +/−1%

| Temp. | Rmax | Rnor | Rmin |
|---|---|---|---|
| (deg. C.) | (k Ohms) | (k Ohms) | (k Ohms) |
| 0 | 334.2264 | 327.0195 | 319.9360 |
| 1 | 317.4508 | 310.7640 | 304.1877 |
| 2 | 301.6157 | 295.4121 | 289.3072 |
| 3 | 286.6631 | 280.9084 | 275.2418 |
| 4 | 272.5389 | 267.2014 | 261.9423 |
| 5 | 259.1926 | 254.2428 | 249.3626 |
| 6 | 246.5770 | 241.9877 | 237.4601 |
| 7 | 234.6482 | 230.3940 | 226.1943 |
| 8 | 223.3650 | 219.4224 | 215.5278 |
| 9 | 212.6890 | 209.0361 | 205.4255 |
| 10 | 202.5840 | 199.2007 | 195.8544 |
| 11 | 193.0167 | 189.8841 | 186.7836 |
| 12 | 183.9552 | 181.0559 | 178.1844 |
| 13 | 175.3704 | 172.6881 | 170.0298 |
| 14 | 167.2345 | 164.7540 | 162.2942 |
| 15 | 159.5216 | 157.2290 | 154.9539 |
| 16 | 152.2075 | 150.0898 | 147.9867 |
| 17 | 145.2694 | 143.3144 | 141.3716 |
| 18 | 138.6861 | 136.8825 | 135.0889 |
| 19 | 132.4375 | 130.7749 | 129.1202 |
| 20 | 126.5049 | 124.9734 | 123.4482 |
| 21 | 120.8705 | 119.4612 | 118.0564 |
| 22 | 115.5180 | 114.2223 | 112.9298 |
| 23 | 110.4316 | 109.2417 | 108.0537 |
| 24 | 105.5969 | 104.5053 | 103.4147 |
| 25 | 101.0000 | 100.0000 | 99.0000 |
| 26 | 96.7127 | 95.7132 | 94.7146 |
| 27 | 92.6306 | 91.6333 | 90.6378 |
| 28 | 88.7426 | 87.7492 | 86.7583 |
| 29 | 85.0386 | 84.0505 | 83.0655 |
| 30 | 81.5090 | 80.5274 | 79.5497 |
| 31 | 78.1446 | 77.1707 | 76.2012 |
| 32 | 74.9370 | 73.9717 | 73.0115 |
| 33 | 71.8779 | 70.9222 | 69.9721 |
| 34 | 68.9598 | 68.0144 | 67.0752 |
| 35 | 66.1755 | 65.2411 | 64.3134 |
| 36 | 63.5182 | 62.5954 | 61.6798 |
| 37 | 60.9814 | 60.0707 | 59.1677 |
| 38 | 58.5591 | 57.6610 | 56.7710 |
| 39 | 56.2456 | 55.3604 | 54.4837 |
| 40 | 54.0355 | 53.1635 | 52.3004 |
| 41 | 51.9235 | 51.0651 | 50.2158 |
| 42 | 49.9049 | 49.0602 | 48.2250 |
| 43 | 47.9752 | 47.1443 | 46.3232 |
| 44 | 46.1298 | 45.3130 | 44.5062 |
| 45 | 44.3649 | 43.5621 | 42.7696 |
| 46 | 42.6764 | 41.8878 | 41.1096 |
| 47 | 41.0607 | 40.2862 | 39.5224 |
| 48 | 39.5143 | 38.7539 | 38.0044 |
| 49 | 38.0339 | 37.2876 | 36.5524 |
| 50 | 36.6163 | 35.8842 | 35.1631 |
| 51 | 35.2587 | 34.5405 | 33.8335 |
| 52 | 33.9582 | 33.2538 | 32.5608 |
| 53 | 32.7121 | 32.0214 | 31.3423 |
| 54 | 31.5178 | 30.8408 | 30.1754 |
| 55 | 30.3731 | 29.7096 | 29.0576 |
| 56 | 29.2755 | 28.6253 | 27.9868 |
| 57 | 28.2230 | 27.5860 | 26.9607 |
| 58 | 27.2135 | 26.5895 | 25.9772 |
| 59 | 26.2450 | 25.6338 | 25.0343 |
| 60 | 25.3156 | 24.7171 | 24.1303 |
| 61 | 24.4237 | 23.8376 | 23.2633 |
| 62 | 23.5675 | 22.9937 | 22.4315 |
| 63 | 22.7454 | 22.1836 | 21.6336 |
| 64 | 21.9560 | 21.4061 | 20.8678 |
| 65 | 21.1977 | 20.6594 | 20.1328 |
| 66 | 20.4692 | 19.9424 | 19.4272 |
| 67 | 19.7693 | 19.2537 | 18.7497 |
| 68 | 19.0966 | 18.5920 | 18.0990 |
| 69 | 18.4499 | 17.9562 | 17.4740 |
| 70 | 17.8282 | 17.3452 | 16.8735 |
| 71 | 17.2304 | 16.7578 | 16.2965 |
| 72 | 16.6554 | 16.1930 | 15.7419 |
| 73 | 16.1023 | 15.6499 | 15.2087 |
| 74 | 15.5702 | 15.1276 | 14.6961 |
| 75 | 15.0581 | 14.6251 | 14.2032 |
| 76 | 14.5652 | 14.1417 | 13.7291 |
| 77 | 14.0907 | 13.6764 | 13.2729 |
| 78 | 13.6339 | 13.2286 | 12.8341 |
| 79 | 13.1940 | 12.7976 | 12.4118 |
| 80 | 12.7703 | 12.3825 | 12.0053 |
| 81 | 12.3622 | 11.9828 | 11.6139 |
| 82 | 11.9689 | 11.5978 | 11.2372 |
| 83 | 11.5900 | 11.2270 | 10.8743 |
| 84 | 11.2247 | 10.8697 | 10.5248 |
| 85 | 10.8727 | 10.5254 | 10.1881 |
| 86 | 10.5332 | 10.1935 | 9.8637 |
| 87 | 10.2059 | 9.8736 | 9.5511 |
| 88 | 9.8902 | 9.5652 | 9.2499 |
| 89 | 9.5858 | 9.2678 | 8.9594 |
| 90 | 9.2920 | 8.9809 | 8.6794 |
| 91 | 9.0085 | 8.7042 | 8.4094 |
| 92 | 8.7350 | 8.4373 | 8.1489 |
| 93 | 8.4710 | 8.1797 | 7.8977 |
| 94 | 8.2161 | 7.9312 | 7.6554 |
| 95 | 7.9700 | 7.6912 | 7.4215 |
| 96 | 7.7324 | 7.4596 | 7.1958 |
| 97 | 7.5029 | 7.2360 | 6.9780 |
| 98 | 7.2812 | 7.0201 | 6.7677 |
| 99 | 7.0670 | 6.8115 | 6.5647 |
| 100 | 6.8601 | 6.6101 | 6.3686 |
| 101 | 6.6601 | 6.4155 | 6.1793 |
| 102 | 6.4668 | 6.2274 | 5.9964 |
| 103 | 6.2799 | 6.0457 | 5.8197 |
| 104 | 6.0993 | 5.8701 | 5.6489 |
| 105 | 5.9246 | 5.7003 | 5.4839 |

For the avoidance of doubt, it will be appreciated by the person skilled in the art that the full range temperature resistance table used and operated for the temperature sensor 370 of FIG. 13 referred to above ranges from about −30° C. to about 108° C.

By referring to FIG. 5, FIG. 10, FIG. 11 and FIG. 12, the processor correlates the measured temperature of the heated liquid (not illustrated) from the temperature sensor 164 with the visual indicator. This means that the processor includes a printed circuit board 142 having an integrated circuit 148 programmed to process an input signal to an output signal. The input signal originates from the temperature sensor 164 and the output signal is directed to the visual indicator, in this case being the red, green and blue colour light emitting diode 150. The processor may be a microcontroller or microprocessor, for example an integrated chip. The processor may execute an algorithm to determine the temperature of the heated liquid measured by the temperature sensor 164.

The visual indicator being the tri-colour LED, selectively illuminates the colours red, blue and green colour specifically to illustrate to the user the discrete temperature and whether the heated liquid in the container is the correct temperature for infant formula preparation.

The colour blue indicates that the temperature range of the heated liquid is <25° C. degrees which is too cold to serve to prepare and serve infant formula. The colour green indicates that the temperature range of the heated liquid is between >25° C. and <45° C. and safe to serve to an infant when mixed with baby formula. The colour red indicates that the temperature range of the heated liquid is >45° C. and is too hot and unsafe to serve to an infant. These different colours (blue, green and red) are directed to illuminate on these pre-determined temperature ranges using the electrical components and arrangements on the printed circuit board 142 in FIG. 5 and fully described herein.

By referring to FIG. 5, operationally the user handles the container that provides temperature range indication to a user 120. The user firstly presses the flexible button 124 once (whilst contemporaneously manoeuvring the chamber 168 by tilting of the user's hand, so that the heated liquid contacts the temperature sensor 164) which pushes the biased leaf 138 to engage the switch 146 to use the power in the rechargeable battery 152 which then powers the necessary current through the printed circuit board 142 to produce a current through the temperature sensor 164 of FIG. 5 being a thermistor which is heated accordingly to the contact temperature of the heated liquid in the container 168, thereby inducing electrical resistance, measurable by the electronics components back to the printed circuit board 142. There is a 1.5 to 2 second delay for the temperature sensor 164 to make the reading and for the red, green and blue colour light emitting diode 150 to illuminate with any one of the colours blue, green and red colour reflecting the predetermined discrete temperature range described herein. This 1.5 to 2 second delay allows time for the user to tilt the container 168 back to vertical so the user can then read which coloured light is emitted by the light emitting diode 150 through the aperture 126.

By referring to FIG. 6, the person skilled in the art would appreciate that when the levels of the heated liquid 184 is high enough in the chamber 186 such that the heated liquid 184 touches the temperature sensor (not numbered but illustrated) there is no need to manoeuvre the chamber 186 by tilting.

By referring to FIG. 5, advantageously in order to recharge the rechargeable battery 152, the user removes the removable cover 122 and then utilises the electric charging port 136 and the USB port 144 to receive a Type A male USB type standard mobile telephone charging cable (not illustrated) for charging the rechargeable battery 152. When the Type A male USB type standard mobile telephone charging cable is engaged to a standard external power socket, the visual indicator in this case being the light emitting diode 150 uniquely illuminates the colour red when the rechargeable battery is recharging. When the visual indicator in this case being the light emitting diode 150 illuminates the colour green, this uniquely illustrates to the user when the rechargeable battery 152 is fully charged and the Type A male USB type standard mobile telephone charging cable (not illustrated) can then be removed from the internal cap 130. The unique combination of the visual indicator that provides both temperature indication on the one hand and rechargeability indication of the rechargeable battery 152 on the other to the user, is quite clever for use in baby infant formula preparation. There is an additional advantage using the chamber 168 as described herein with the use of the inner wall and outer wall separated by an insulation layer comprising a vacuum space, all providing high quality heat retaining function of heated liquid in baby infant formula preparation.

The person skilled in the art would appreciate that having regard to the unique and inventive combination and cooperation of all components and features of the container that provides temperature range indication to a user 10 of FIG. 1 and described herein, provides a substantial improvement for the use of heated liquid in the preparation of milk/formula for babies and infants for their health and safety.

Although the container that provides temperature range indication to a user 10 can be used for the preparation of baby infant formulation, it can also be used in schools, hospitals and nursing homes for the preparation of coffee and tea.

In an alternative embodiment, given the structure of the chamber 12 described above, the chamber 12 can maintain chilled water for up to twenty-four (24) hours such that the container that provides temperature range indication to a user 10 can be used as a drink bottle.

In an alternative embodiment, the chamber 12 can be of any suitable shape such as the bottle shape of FIG. 1 or any other variation.

One advantage of the container that provides temperature range indication to a user, is that the visual indicator illustrates to the user that the heated liquid is safe to use for baby infant formula preparation.

Another advantage of the container that provides temperature range indication to a user, is that there is no liquid bulb-type thermometer making it safer to use for infants and babies.

Throughout this specification and the claims which follow, unless the context requires otherwise, the word “comprise” and variations such as “comprises” or “comprising”, will be understood to imply the inclusion of a stated integer or step or group of integers or steps but not the exclusion of any other integer or step or group of integers or steps.

A reference to any prior art in this Specification is not, and should not be taken as, an acknowledgment or any form or suggestion that the prior art forms part of the common general knowledge.

Various alterations and/or additions may be made to the container that provides temperature range indication to a user hereinbefore described in this Specification, without departing from the spirit, ambit or scope of the invention.

1. A container that provides temperature range indication to a user, the container including:
a chamber for holding heated liquid;
an outlet for dispensing the heated liquid from the chamber;
a cap sealably connected to the outlet;
the cap including:
(a) a visual indicator adapted to selectively illuminate a plurality of visual colors, wherein each one of the visual colors represents a pre-determined discrete temperature range;
(b) a temperature sensor, extending inside the chamber that measures the temperature of the heated liquid;
(c) a power supply adapted to power the temperature sensor and visual indicator; and
(d) a switch operable by the user to engage the power supply;
(e) a processor that correlates the measured temperature of the heated liquid from the temperature sensor with the visual indicator,
wherein in use, illumination of each one of the visual colors represents to the user the discrete temperature range of the heated liquid.

2. The container according to claim 1, wherein the chamber is maneuverable so that the heated liquid contacts the temperature sensor.

3. The container according to claim 1, wherein the processor includes a printed circuit board having an integrated circuit programmed to process an input signal to an output signal, wherein the input signal originates from the temperature sensor and the output signal is directed to the visual indicator.

4. (canceled)

5. The container according to claim 1, wherein the visual indicator includes a red, green, blue light color emitting diode.

6. The container according to claim 5, wherein the color green represents the temperature range of the heated liquid being >25° C. to <45° C., wherein the color blue represents the temperature range of the heated liquid <25° C., wherein the color red represents the temperature range of the heated liquid >45° C.

7-8. (canceled)

9. The container according to claim 1, wherein the switch includes a button being spring loaded or flexibly biased.

10. The container according to claim 1, wherein the cap further includes an electric charging port to charge the power supply, wherein the electric charging port includes a USB port.

11. (canceled)

12. The container according to claim 1, wherein the power supply includes a rechargeable battery.

13. The container according to claim 12, wherein the visual indicator illuminates a color red when the rechargeable battery is recharging, wherein the visual indicator illuminates a color green when the rechargeable battery is fully charged.

14. (canceled)

15. The container according to claim 1, wherein the cap includes a removable cover.

16. The container according to claim 15, wherein the removable cover is constructed from flexible silicone.

17. The container according to claim 1, wherein the chamber includes an outer wall and inner wall separated by vacuum insulation.

18. The container according to claim 17, wherein the inner wall includes heat insulation coating.

19. The container according to claim 18, wherein the heat insulation coating includes coated copper.

20. The container according to claim 1, wherein the temperature sensor includes a thermistor.

21. The container according to claim 1, wherein the heated liquid is used for baby infant formula preparation, wherein the heated liquid is or includes water.

22. (canceled)

23. The container according to claim 1, wherein the cap inter-engages a circularly discontinuous broad first thread disposed adjacent the outlet and having raised portions.

24. The container according to claim 1, wherein the cap inter-engages a circularly discontinuous first thread disposed adjacent the outlet and a second thread having raised channels disposed on the first thread.
